(19) United States
(12) Patent Application Publication
(10) Pub. No.: US 2025/0333319 A1
(43) Pub. Date: Oct. 30, 2025

(54) PROCESS FOR PRODUCING LITHIUM HYDROXIDE MONOHYDRATE

(71) Applicant: Albemarle Corporation, Charlotte, NC (US)

(72) Inventors: Yongqiang TAN, Charlotte, NC (US); Stephen E. BELMONT, Gastonia, NC (US); Richard A. Holub, Charlotte, NC (US)

(73) Assignee: Albemarle Corporation, Charlotte, NC (US)

(21) Appl. No.: 18/868,492

(22) PCT Filed: May 23, 2023
(86) PCT No.: PCT/US2023/023208

§ 371 Date: Nov. 22, 2024

Related U.S. Application Data
(60) Provisional application No. 63/345,583, filed on May 25, 2022.

(51) Int. Cl. C01D 15/02

(52) U.S. Cl. CPC C01D 15/02; C01P 2006/80

(57) ABSTRACT

One or more processes for producing lithium hydroxide monohydrate and related systems are described herein. One or more of the processes generally include feeding a slurry to one or more gravity separators, and separating the slurry using the one or more gravity separators into an underflow slurry and overflow slurry. The slurry comprises lithium hydroxide monohydrate and one or more insoluble impurities.

### FIELD

The present disclosure relates generally to the production lithium hydroxide monohydrate. More specifically, the present disclosure relates to one or more processes for producing lithium hydroxide monohydrate and related systems.

### BACKGROUND

This section introduces information that may be related to or provide context for some aspects of the techniques described herein and/or claimed below. This information is background facilitating a better understanding of that which is disclosed herein. Such background may include a discussion of “related” art. That such art is related in no way implies that it is also “prior” art. The related art may or may not be prior art. The discussion is to be read in this light, and not as admissions of prior art.

In recent years, lithium has grown in importance as an element for use in a variety of applications, particularly for use in batteries with high energy density. Lithium can be found in a variety of sources including brines, mineral deposits (e.g., spodumene and lepidolite), and clays throughout various parts of the world. Such lithium sources can undergo further processing to produce lithium hydroxide monohydrate, which is increasingly used for battery applications particularly in the automotive industry. Such battery applications can require lithium hydroxide monohydrate having low levels of impurities including, among others, calcium, sodium, chlorides, and sulfates. Producing lithium hydroxide monohydrate with a low impurities content can be difficult without employing one or more purification steps. One method for removing such impurities involves using ion exchange and/or soda ash treatment to remove impurities such as calcium. But, purification involving ion exchange and/or soda ash methods can suffer from drawbacks such as additional time and cost to produce the desired lithium hydroxide monohydrate product, as well as additional raw materials and waste streams.

Thus, there is an ongoing need to develop new processes for producing lithium hydroxide monohydrate and related systems.

### SUMMARY

In general, the present disclosure provides a process that includes (A) feeding a slurry to one or more gravity separators, wherein the slurry comprises lithium hydroxide monohydrate and one or more insoluble impurities; and (B) separating the slurry based on particle size using the one or more gravity separators into an underflow slurry and an overflow slurry. The process may further include feeding the underflow slurry to one or more centrifuges to form a separated underflow. The process may further include dissolving and recrystallizing the separated underflow to reform a recrystallized underflow. The process may further include washing the recrystallized underflow to form a purified lithium hydroxide monohydrate.

One or more aspects of the disclosure include the process of any preceding paragraph in which the gravity separators comprise one or more hydrocyclones.

One or more aspects of the disclosure include the process of any preceding paragraph in which the gravity separators comprise one or more settling tanks.

One or more aspects of the disclosure include the process of any preceding paragraph in which the separated underflow has a calcium content of less than about 60 ppm.

One or more aspects of the disclosure include the process of any preceding paragraph in which the purified lithium hydroxide monohydrate has a calcium content of less than about 25 ppm.

One or more aspects of the disclosure include the process of any preceding paragraph in which in step (A) the slurry has a lithium hydroxide monohydrate content in a range of about 10 wt. % to about 50 wt. % based on a total weight of the slurry.

One or more aspects of the disclosure include the process of any preceding paragraph in which the insoluble impurities comprise one or more calcium-containing compounds, one or more carbonate-containing compounds, or both.

One or more aspects of the disclosure include the process of any preceding paragraph in which the insoluble impurities comprise one selected from the group consisting of CaCO₃, Ca(OH)₂, Li₂CO₃, CaSO₄, and any combination of two or more of the foregoing.

One or more aspects of the disclosure include the process of any preceding paragraph in which the slurry is formed by contacting an aqueous solution comprising lithium sulfate with sodium hydroxide, wherein the aqueous solution has a calcium content greater than about 300 ppm.

One or more aspects of the disclosure include the process of any preceding paragraph in which the gravity separators have a cut point of about 50 micrometers or less.

One or more aspects of the disclosure include the process of any preceding paragraph in which an ion exchanger is not used.

One or more aspects of the disclosure include the process of any preceding paragraph in which soda ash treatment is not used.

While multiple embodiments are disclosed, still other embodiments will become apparent to those skilled in the art from the following detailed description. As will be apparent, certain embodiments, as disclosed herein, are capable of modifications in various obvious aspects, all without departing from the spirit and scope of the claims as presented herein. Accordingly, the drawings and detailed description are to be regarded as illustrative in nature and not restrictive.

### BRIEF DESCRIPTION OF THE DRAWING(S)

For a detailed description of the preferred embodiments of the disclosed embodiments, reference will now be made to the accompanying drawing(s) in which:

FIG. 1 illustrates a process for producing lithium hydroxide monohydrate in accordance with certain aspects of the present disclosure.

While the claimed subject matter is susceptible to various modifications and alternative forms, the drawing(s) illustrate specific embodiments herein described in detail by way of example. It should be understood, however, that the description herein of specific embodiments is not intended to limit the claimed subject matter to the particular forms disclosed, but on the contrary, the intention is to cover all modifications, equivalents, and alternatives falling within the spirit and scope as defined by the appended claims.

### DEFINITIONS

To define more clearly the terms used in this disclosure, the following definitions are provided. Unless otherwise indicated, the following definitions are applicable to this disclosure. Terms that do not appear below have their ordinary and customary meaning understood in the context of this disclosure by a person of ordinary skill in the art relating to the technical field of this disclosure. To the extent that any definition or usage provided by any document incorporated here by reference conflicts with the definition or usage provided herein, the definition or usage provided in this disclosure controls.

In this disclosure, features of the subject matter are described such that, within particular aspects, a combination of different features can be envisioned. For each and every aspect and each and every feature disclosed herein, all combinations that do not detrimentally affect the designs, systems, compositions, processes, or methods described herein are contemplated with or without explicit description of the particular combination. Additionally, unless explicitly recited otherwise, any aspect or feature disclosed herein can be combined to describe inventive designs, systems, compositions, processes, or methods consistent with the present disclosure.

In this disclosure, while compositions and methods are often described in terms of “comprising” various components or steps, the compositions and methods can also “consist essentially of” or “consist of” the various components or steps, unless stated otherwise. For example, a slurry consistent with aspects of the disclosed subject matter can comprise; alternatively, can consist essentially of; or alternatively, can consist of; lithium hydroxide monohydrate and one or more insoluble impurities.

The terms “a,” “an,” and “the” are intended to include plural alternatives, e.g., at least one, one or more, and one or more than one, unless otherwise specified. For example, the disclosure of “a slurry” is meant to encompass one, or mixtures or combinations of more than one, slurry, unless otherwise specified.

The term “contacting” is used herein to describe systems, compositions, processes, and methods in which the components are contacted, combined, or brought together in any order, in any manner, and for any length of time, unless otherwise specified. For example, the components can be combined by blending or mixing, using any suitable technique.

The term “particle size” refers to the median diameter or median value of particle size distribution as determined by a laser diffraction method or other suitable method known to one of ordinary skill in the art.

The term “cut point” means the particle size at which a particle has about a 50-50 chance of reporting to either the underflow or overflow of a gravity separator.

The term “about” means that amounts, sizes, formulations, parameters, and other quantities and characteristics are not and need not be exact, but may be approximate including being larger or smaller, as desired, reflecting tolerances, conversion factors, rounding off, measurement errors, and the like, and other factors known to those of skill in the art. In general, an amount, size, formulation, parameter or other quantity or characteristic is “about” or “approximate” whether or not expressly stated to be such. The term “about” also encompasses amounts that differ due to different equilibrium conditions for a composition resulting from a particular initial mixture. Whether or not modified by the term “about,” the claims include equivalents to the quantities.

Various numerical ranges are disclosed herein. When a range of any type is disclosed or claimed herein (e.g., “ranging from . . . ”, “in a range of from . . . ”, “in the range of from . . . ”, “in a range of from”, “in a range of”) the intent is to disclose or claim individually each possible number that such a range could reasonably encompass, including end points of the range as well as any sub-ranges and combinations of sub-ranges encompassed therein, unless otherwise specified. For example, the present disclosure recites that the slurry has a lithium hydroxide monohydrate content in a range of about 25 wt. % to about 30 wt. % based on a total weight of the slurry in certain aspects. By a disclosure that the lithium hydroxide monohydrate content can be in a range of about 25 wt. % to about 30 wt. %, the intent is to recite that the lithium hydroxide monohydrate content can be any content within the range and, for example, can be equal to about 25 wt. %, about 26 wt. % about 27 wt. % about 28 wt. % about 29 wt. %, or about 30 wt. %. Additionally, the lithium hydroxide monohydrate content can be within any range of about 25 wt. % to about 30 wt. % (for example, the lithium hydroxide monohydrate content can be in a range from about 27 wt. % to about 29 wt. %), and this also includes any combination of ranges between about 25 wt. % to about 30 wt. %. Likewise, all other ranges disclosed herein should be interpreted in a manner similar to this example.

Embodiments disclosed herein can provide the materials listed as suitable for satisfying a particular feature of the embodiment delimited by the term “or.” For example, a particular feature of the disclosed subject matter can be disclosed as follows: Feature X can be A, B, or C. It is also contemplated that for each feature the statement can also be phrased as a listing of alternatives such that the statement “Feature X is A, alternatively B, or alternatively C” is also an embodiment of the present disclosure whether or not the statement is explicitly recited.

Although any methods and materials similar or equivalent to those described herein can be used in the practice or testing of the subject matter described herein, the typical methods and materials are herein described.

All publications and patents mentioned herein are incorporated herein by reference for the purpose of describing and disclosing, for example, the constructs and methodologies that are described in the publications, which can be used in connection with the presently described subject matter.

### DETAILED DESCRIPTION

Illustrative aspects of the subject matter claimed below will now be disclosed. In the interest of clarity, not all features of an actual implementation are described in this specification. It will be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

### A. Process for Producing Lithium Hydroxide Monohydrate

Aspects of the subject matter disclosed herein are directed to one or more processes for producing lithium hydroxide monohydrate (LHM). One such process may comprise:
(A) feeding a slurry to one or more gravity separators, wherein the slurry comprises lithium hydroxide monohydrate and one or more insoluble impurities; and
(B) separating the slurry based on particle size using the one or more gravity separators into an underflow slurry and an overflow slurry.

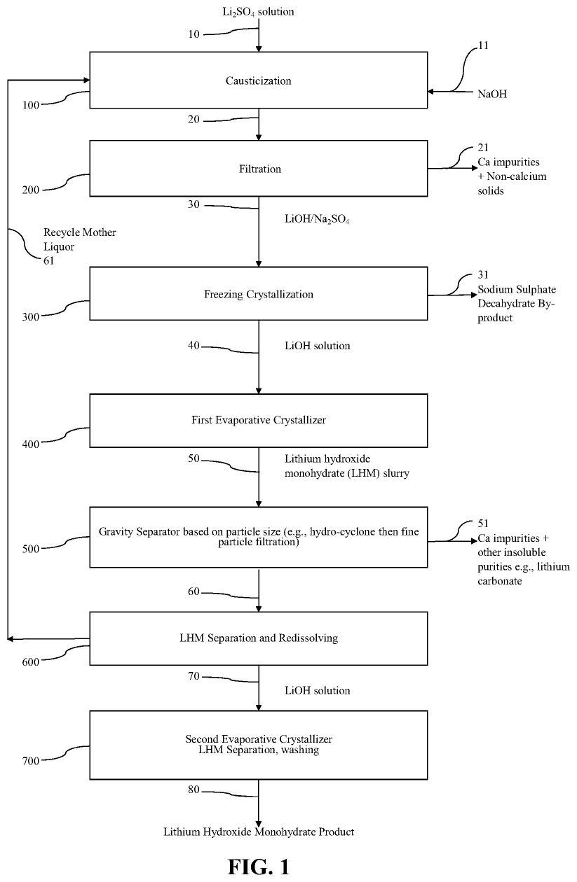

A representative process flow diagram of a system and/or process consistent with certain aspects of this disclosure is illustrated in FIG. 1. Referring now to FIG. 1 and steps (A) and (B), at 50 the slurry may be subjected to a separation process 500 by feeding the slurry to the one or more gravity separators using any suitable motive device, for example, a pump. The one or more gravity separators separate the slurry 50 into the underflow slurry 60 and an overflow slurry 51. The overflow slurry 51 may be subjected to further filtration to remove insoluble impurities from the overflow slurry 51 to form a filtered overflow slurry, which may be recycled in the process for further optimization. The one or more gravity separators 500 may be any suitable gravity separator capable of separating the slurry based on particle size. Non-limiting examples of suitable gravity separators may include separators using cyclonic action (e.g., hydrocyclones), settling tanks, or both. In aspects, the one or more gravity separators may comprise one or more hydrocyclones, or two or more hydrocyclones. Non-limiting examples of a suitable hydrocyclones include FX-100 hydrocyclones available from Weihai Haiwang Hydrocyclone Co., LTD.

While not wishing to be bound by theory, it is believed that many of the insoluble impurities present in the slurry (e.g., calcium-containing compounds) have a sufficiently different particle size in comparison to lithium hydroxide monohydrate so as to permit separation by one or more gravity separators. For example, in the case of one or more hydrocyclones as the gravity separators, the slurry can enter an inlet of a hydrocyclone having a conical chamber to form a vortex inside the conical chamber. At least a portion of the coarser particles such as lithium hydroxide monohydrate can settle out and exit the hydrocyclones as the underflow slurry, and at least a portion of finer particles such as calcium-containing compounds can remain in suspension and exit the hydrocyclones as the overflow slurry. In this manner, the slurry can be sufficiently separated based on particle size, or based at least in part on particle size or a measure indicative of particle size.

Various operating and sizing parameters can be utilized for the one or more gravity separators to ensure the desired separation of the slurry based on particle size. In aspects, the one or more gravity separators may be sized and configured to have a cut point of less than about 100 micrometers, or alternatively less than about 75 micrometers, or alternatively less than about 50 micrometers, or alternatively about 25 micrometers, or alternatively less than about 10 micrometers. The temperature may be in a range of about 20° C. to about 80° C., or alternatively about 50° C. to about 60° C. The pressure may be in a range of about 0.5 bar to about 3 bar, alternatively about 0.7 bar to about 1 bar, or alternatively about 0.9 bar. The slurry may be fed to the one or more gravity separators at any suitable flow rate depending on the desired cut point and/or desired production rate of lithium hydroxide monohydrate. In some aspects, the one or more gravity separators may have an inner diameter in a range of about 10 mm to about 400 mm. For example, the one or more gravity separators may have an inner diameter of about 100 mm, a height of about 1069 mm, and a bottom discharge port size of about 18 mm. The slurry may be fed to the one or more gravity separators at a flow rate in a range of about 7 m³/hour to about 9 m³/hour, or alternatively about 8 m³/hour. The overflow slurry from the one or more gravity separators may have at flow rate in a range of about 3 m³/hour to about 4 m³/hour. In aspects, to achieve the desired flow distribution between the overflow slurry and the underflow slurry, the size of the underflow slurry discharge outlet of the gravity separator may be varied.

In at least some aspects of the disclosure, the slurry 50 has a lithium hydroxide monohydrate content in a range of about 10 wt. % to about 50 wt. % based on a total weight of the slurry, or alternatively a lithium hydroxide monohydrate content in a range of about 25 wt. % to about 30 wt. % based on a total weight of the slurry.

The slurry 50 may be formed by a variety of processes. For example and as shown in FIG. 1, the slurry 50 may be formed in a causticization process 100 by contacting an aqueous solution 10 comprising lithium sulfate with sodium hydroxide 11 under conditions sufficient to produce a solution 20 comprising lithium hydroxide and sodium sulfate. In aspects, the aqueous solution 10 comprising lithium sulfate has a calcium content greater than about 300 ppm. The solution 20 comprising lithium hydroxide and sodium sulfate can be subjected to a filtration process 200 to remove certain impurities 21 to form a filtered solution 30 comprising lithium hydroxide and sodium sulfate. The filtered solution 30 may have a calcium content of less than about 30 ppm, or alternatively less than about 20 ppm. The filtered solution 30 can be subjected to a freezing crystallization process 300 to remove sodium sulfate decahydrate solids 31. Subsequently, the solution 40 comprising lithium hydroxide and other impurities can be fed to an evaporative crystallizer 400 to form the slurry 50. As another example, the slurry 50 may be formed by contacting lithium hydroxide monohydrate containing insoluble impurities with water.

The insoluble impurities in the slurry 50 may comprise one or more calcium-containing compounds, one or more carbonate-containing compounds, or both. Non-limiting examples of insoluble impurities may include calcium carbonate (CaCO₃), calcium hydroxide (Ca(OH)₂), lithium carbonated (Li₂CO₃), calcium sulfate (CaSO₄), or any combination of two or more of the foregoing.

Insoluble impurities content as described herein, such as the amount of calcium present (on a ppm basis), can be determined by ICP-OES (Inductively Coupled Plasma-Optical Emission Spectroscopy).

In at least some aspects of the disclosure, the process may further comprise: (C) feeding the underflow slurry to one or more centrifuges to form a separated underflow.

Referring now to step (C) and FIG. 1, a separation process 600 comprising one or more separators such as centrifuges may be used to separate mother liquor 61 from the underflow slurry to form the separated underflow 70. The mother liquor may be recycled back to the causticization process 100. The one or more centrifuges may be any suitable centrifuge capable of forming a separated underflow having a desired moisture content. Non-limiting examples of suitable centrifuges may include pusher centrifuges such as HR-400 centrifuges made by Saideli of China.

In at least some aspects of the disclosure, the separated underflow 70 has a moisture content of no more than about 10 wt. %, or alternatively no more than about 5 wt. %, or alternatively about 5 wt. %. Reference to “moisture content” means the amount of residual water on the lithium hydroxide monohydrate solids in the centrifuge. The separated underflow has a calcium content of less than about 60 ppm. alternatively less than about 50 ppm, or alternatively less than about 30 ppm.

In at least some aspects of the disclosure, the process may further comprise: (D) dissolving and recrystallizing the separated underflow to reform a recrystallized underflow.

Referring to step (D) and FIG. 1 at 700, the separated underflow 70 is dissolved in a solution comprising water, lithium hydroxide or both to form a concentrated lithium hydroxide solution. The concentrated lithium hydroxide solution may be fed to a second evaporative crystallizer to produce lithium hydroxide monohydrate solids, which can be separated by one or more hydrocyclones and/or centrifuges as the recrystallized underflow and in certain applications no subsequent redissolving is required.

In at least some aspects of the disclosure, the process may further comprise: (E) washing the recrystallized underflow to form a purified lithium hydroxide monohydrate.

Referring to step (E) and FIG. 1 at 700, washing the recrystallized underflow may further reduce the amount of calcium and other impurities that may be present. The term washing, as used herein, is meant to include any process where liquid (e.g. water) is contacted with the recrystallized underflow. One or more washings may be necessary to substantially reduce the impurities in the recrystallized underflow. In at least some aspects of the disclosure, after the washing step, the purified lithium hydroxide monohydrate 80 has a calcium content of less than about 25 ppm, or alternatively less than about 20 ppm.

In at least some aspects of the disclosure, the process described herein may be implemented without the use of an ion exchange, without use of soda ash treatment, or without use of both ion exchange and soda ash treatment.

In at least some aspects of the disclosure, at least a portion of the material subjected to the process disclosed herein (e.g., the slurry, materials employed to the slurry, or both) is not purified by (i) an ion exchange, (ii) soda ash treatment, or both (i) and (ii).

### EXAMPLES

The subject matter having been generally described, the following examples are given as particular embodiments of the subject matter of this disclosure and to demonstrate the practice and advantages thereof. It is understood that the examples are given by way of illustration and are not intended to limit the claims to follow in any manner.

### Comparative Example 1 (Run Without Hydrocyclone)

A slurry having 25 wt. % to 30 wt. % lithium hydroxide monohydrate was discharged from an evaporative crystallizer and fed to a cooling crystallizer. The slurry was then fed from the cooling crystallizer to a peeler centrifuge (LGZ1250 made by Saideli of China) by gravity flow to separate the slurry into an aqueous mother liquor and separated lithium hydroxide monohydrate solids in batch operation. Each batch produced about 250 kg to about 280 kg of separated lithium hydroxide monohydrate solids. The separated lithium hydroxide monohydrate solids were redissolved, recrystallized and washed to form purified lithium hydroxide monohydrate.

### Example 1 (Run With Hydrocyclone)

A slurry having 25 wt. % to 30 wt. % lithium hydroxide monohydrate was discharged from an evaporative crystallizer and fed into a cooling crystallizer. The slurry was then fed by pump into a cone shaped stainless steel hydrocyclone. The FX-100 hydrocyclone (made by Haiwang of China) had an inner diameter of 100 mm, height of 1069 mm, and bottom discharge port size of 18 mm. The slurry was fed into the hydrocyclone at a flow rate of 8 m³/hour. The overflow from the top of hydrocyclone had a flow rate of 3 m³/hour to 4 m³/hour. The underflow from the bottom of the hydrocyclone was fed into a pusher centrifuge (HR-400 made by Saideli of China) which separated the slurry into an aqueous mother liquor and separated lithium hydroxide monohydrate solids. The separated lithium hydroxide monohydrate solids were redissolved, recrystallized and washed to form purified lithium hydroxide monohydrate.

The data and results for Comparative Example 1 and Example 1 are summarized below in Table 1.

TABLE 1

| | | Comparative | |
|---|---|---|---|
| Parameter | Unit | Example 1 | Example 1 |
| Slurry Flow Rate | m³/hour | 8 | 8 |
| Lithium Hydroxide | wt. % | 25 to 30 | 25 to 30 |
| Monohydrate | | | |
| Content of Slurry | | | |
| Feed | | | |
| Overflow Slurry | m³/hour | Not | 3 to 4 |
| Flow Rate | | Applicable. | |
| Centrifuge Type | Not | Centrifuge | Centrifuge |
| | Applicable. | (Peeler Type) | (Pusher Type) |
| Moisture Content | wt. % | 3 | 5 |
| of Separated | | | |
| Underflow | | | |
| Calcium Content | ppm | 118 | 27 |
| of Separated | | | |
| Underflow | | | |
| Calcium Content | ppm | 67 | 11 |
| of Purified Lithium | | | |
| Hydroxide | | | |
| Monohydrate | | | |

The hydrocyclone and process of producing lithium hydroxide monohydrate using the hydrocyclone as described herein can thus be used to produce a separated lithium hydroxide monohydrate with a reduced calcium content. For example and as illustrated by the above examples, the hydrocyclone and process of producing lithium hydroxide monohydrate using the hydrocyclone as described herein can be used to produce a separated lithium hydroxide monohydrate with a calcium content of about 27 ppm, a reduction of about 77% in comparison to a process in which a hydrocyclone is not employed. Further, the hydrocyclone and process of producing lithium hydroxide monohydrate using the hydrocyclone as described herein can thus be used to produce a purified lithium hydroxide monohydrate with a calcium content of about 11 ppm, a reduction of about 83% in comparison to a process in which a hydrocyclone is not employed.

### ADDITIONAL DESCRIPTION

The subject matter is described above with reference to numerous aspects and specific examples. Many variations will suggest themselves to those skilled in the art in light of the above detailed description. All such obvious variations are within the full intended scope of the appended claims. Other aspects of the subject matter disclosed herein can include, but are not limited to, the following (aspects are described as “comprising” but, alternatively, can “consist essentially of”, or “consist of”):

Aspect 1. A process for producing lithium hydroxide monohydrate, the process comprising the steps of: (A) feeding a slurry to one or more gravity separators, wherein the slurry comprises lithium hydroxide monohydrate and one or more insoluble impurities; and (B) separating the slurry based on particle size using the one or more gravity separators into an underflow slurry and an overflow slurry.

Aspect 2. The process defined in Aspect 1, wherein the process further comprises (C) feeding the underflow slurry to one or more centrifuges to form a separated underflow.

Aspect 3. The process defined in any one of Aspects 1-2, wherein the process further comprises (D) dissolving and recrystallizing the separated underflow to reform a recrystallized underflow.

Aspect 4. The process defined in any one of Aspects 1-3, wherein the process further comprises (E) washing the recrystallized underflow to form a purified lithium hydroxide monohydrate.

Aspect 5. The process defined in any one of Aspects 1-4, wherein the gravity separators comprise one or more hydrocyclones.

Aspect 6. The process defined in any one of Aspects 1-5, wherein the gravity separators comprise one or more settling tanks.

Aspect 7. The process defined in any one of Aspects 2-6, wherein the separated underflow has a calcium content of less than about 60 ppm.

Aspect 8. The process defined in any one of Aspects 4-7, wherein the purified lithium hydroxide monohydrate has a calcium content of less than about 25 ppm.

Aspect 9. The process defined in any one of Aspects 1-8, wherein in step (A) the slurry has a lithium hydroxide monohydrate content in a range of about 10 wt. % to about 50 wt. % based on a total weight of the slurry.

Aspect 10. The process defined in any one of Aspects 1-9, wherein the insoluble impurities comprise one or more calcium-containing compounds, one or more carbonate-containing compounds, or both.

Aspect 11. The process defined in any one of Aspects 1-10, wherein the insoluble impurities comprise one selected from the group consisting of CaCO₃, Ca(OH)₂, Li₂CO₃, CaSO₄, and any combination of two or more of the foregoing.

Aspect 12. The process defined in any one of Aspects 1-11, wherein the slurry is formed by contacting an aqueous solution comprising lithium sulfate with sodium hydroxide, wherein the aqueous solution has a calcium content greater than about 300 ppm.

Aspect 13. The process defined in any one of Aspects 1-12, wherein the gravity separators have a cut point of about 50 micrometers or less.

Aspect 14. The process defined in any one of Aspects 1-13, wherein an ion exchanger is not used.

Aspect 15. The process defined in any one of Aspects 1-14, wherein soda ash treatment is not used.

Aspect 16. A process for producing lithium hydroxide monohydrate, the process comprising the steps of (A) feeding a slurry to one or more gravity separators, wherein the slurry comprises lithium hydroxide monohydrate and one or more insoluble impurities; (B) separating the slurry based on particle size using the one or more gravity separators into an underflow slurry and an overflow slurry; (C) feeding the underflow slurry to one or more centrifuges to form a separated underflow; and (D) dissolving and recrystallizing the separated underflow to reform a recrystallized underflow.

Aspect 17. The process as defined in Aspect 16, wherein the gravity separators comprise one or more hydrocyclones.

Aspect 18. The process as defined in Aspect 16, wherein the gravity separators comprise one or more settling tanks.

Aspect 19. The process as defined in an preceding Aspect, wherein the separated underflow has a calcium content of less than about 60 ppm.

Aspect 20. The process as defined in any preceding Aspect, wherein the purified lithium hydroxide monohydrate has a calcium content of less than about 25 ppm.

Aspect 21. The process as defined in any preceding Aspect, wherein in step (A) the slurry has a lithium hydroxide monohydrate content in a range of about 10 wt. % to about 50 wt. % based on a total weight of the slurry.

Aspect 22. The process as defined in any preceding Aspect, wherein the insoluble impurities comprise one or more calcium-containing compounds, one or more carbonate-containing compounds, or both.

Aspect 23. The process as defined in any preceding Aspect, wherein the insoluble impurities comprise one selected from the group consisting of CaCO₃, Ca(OH)₂, Li₂CO₃, CaSO₄, and any combination of two or more of the foregoing.

Aspect 24. The process as defined in any preceding Aspect, wherein the slurry is formed by contacting an aqueous solution comprising lithium sulfate with sodium hydroxide, wherein the aqueous solution has a calcium content greater than about 300 ppm.

Aspect 25. The process as defined in any preceding Aspect, wherein the gravity separators have a cut point of about 50 micrometers or less.

Aspect 26. The process as defined in any preceding Aspect, wherein the gravity separators have a cut point of about 100 micrometers or less.

Aspect 27. The process as defined in any preceding Aspect, wherein an ion exchanger is not used.

Aspect 28. The process as defined in any preceding Aspect, wherein soda ash treatment is not used.

Aspect 29. A process for producing lithium hydroxide monohydrate, the process comprising the steps of: (A) feeding a slurry to one or more gravity separators, wherein the slurry comprises lithium hydroxide monohydrate and one or more insoluble impurities; and (B) separating the slurry based on the specific gravity of different particles using the one or more gravity separators into an underflow slurry and an overflow slurry.

Aspect 30. A process for producing lithium hydroxide monohydrate as in any proceeding aspect, wherein in step (B) the separating is based at least in part on the specific gravity of different particles using the one or more gravity separators into an underflow slurry and an overflow slurry.

1. A process for producing lithium hydroxide monohydrate, the process comprising the steps of:
(A) feeding a slurry to one or more gravity separators, wherein the slurry comprises lithium hydroxide monohydrate and one or more insoluble impurities; and
(B) separating the slurry based on particle size using the one or more gravity separators into an underflow slurry and an overflow slurry.

2. The process of claim 1 further comprising:
(C) feeding the underflow slurry to one or more centrifuges to form a separated underflow.

3. The process of claim 2 further comprising:
(D) dissolving and recrystallizing the separated underflow to reform a recrystallized underflow.

4. The process of claim 3 further comprising:
(E) washing the recrystallized underflow to form a purified lithium hydroxide monohydrate.

5. The process of claim 1, wherein the gravity separators comprise one or more hydrocyclones.

6. The process of claim 1, wherein the gravity separators comprise one or more settling tanks.

7. The process of claim 2, wherein the separated underflow has a calcium content of less than about 60 ppm.

8. The process of claim 4, wherein the purified lithium hydroxide monohydrate has a calcium content of less than about 25 ppm.

9. The process of claim 1, wherein in step (A) the slurry has a lithium hydroxide monohydrate content in a range of about 10 wt. % to about 50 wt. % based on a total weight of the slurry.

10. The process of claim 1, wherein the insoluble impurities comprise one or more calcium-containing compounds, one or more carbonate-containing compounds, or both.

11. The process of claim 1, wherein the insoluble impurities comprise one selected from the group consisting of CaCO₃, Ca(OH)₂, Li₂CO₃, CaSO₄, and any combination of two or more of the foregoing.

12. The process of claim 1, wherein the slurry is formed by contacting an aqueous solution comprising lithium sulfate with sodium hydroxide, wherein the aqueous solution has a calcium content greater than about 300 ppm.

13. The process of claim 1, wherein the gravity separators have a cut point of about 50 micrometers or less.

14. The process of claim 1, wherein an ion exchanger is not used.

15. The process of claim 1, wherein soda ash treatment is not used.

16. A process for producing lithium hydroxide monohydrate, the process comprising the steps of:
(A) feeding a slurry to one or more gravity separators, wherein the slurry comprises lithium hydroxide monohydrate and one or more insoluble impurities;
(B) separating the slurry based on particle size using the one or more gravity separators into an underflow slurry and an overflow slurry;
(C) feeding the underflow slurry to one or more centrifuges to form a separated underflow; and
(D) dissolving and recrystallizing the separated underflow to reform a recrystallized underflow.

17. The process of claim 16, wherein the gravity separators comprise one or more hydrocyclones.

18. The process of claim 16, wherein the gravity separators comprise one or more settling tanks.

19. The process of claim 17, wherein the separated underflow has a calcium content of less than about 60 ppm.

20. The process of claim 17, wherein the purified lithium hydroxide monohydrate has a calcium content of less than about 25 ppm.

21. The process of claim 17, wherein in step (A) the slurry has a lithium hydroxide monohydrate content in a range of about 10 wt. % to about 50 wt. % based on a total weight of the slurry.

22. The process of claim 17, wherein the insoluble impurities comprise one or more calcium-containing compounds, one or more carbonate-containing compounds, or both.

23. The process of claim 17, wherein the insoluble impurities comprise one selected from the group consisting of CaCO₃, Ca(OH)₂, Li₂CO₃, CaSO₄, and any combination of two or more of the foregoing.

24. The process of claim 17, wherein the slurry is formed by contacting an aqueous solution comprising lithium sulfate with sodium hydroxide, wherein the aqueous solution has a calcium content greater than about 300 ppm.

25. The process of claim 17, wherein the gravity separators have a cut point of about 50 micrometers or less.

26. The process of claim 17, wherein the gravity separators have a cut point of about 100 micrometers or less.

27. The process of claim 17, wherein an ion exchanger is not used.

28. The process of claim 17, wherein soda ash treatment is not used.
